(19) United States
(12) Patent Application Publication
(10) Pub. No.: US 2014/0204347 A1
(43) Pub. Date: Jul. 24, 2014

(54) Message Projection System

(71) Applicant: Brenda Murphy, (US)

(72) Inventor: Terry Murphy, Richmond, KY (US)

(73) Assignee: Qunomic Virtual Technology, LLC

(21) Appl. No.: 13/746,849

(22) Filed: Jan. 22, 2013

(51) Int. Cl. G03B 21/14

(52) U.S. Cl. CPC G03B 21/14
USPC 353/57; 353/102

(57) ABSTRACT

A message display that produces a visible message by projecting an image on a surface such as a wall or floor. A bright light source is provided, preferably including an array of light emitting diodes (“LED's”). The light from this bright source is passed through one or more lenses in a condenser assembly to make it more uniform. The light then passes through an image plate that contains a small version of the image to be displayed. Once the light passes through the image plate it next passes through a focusing assembly. The focusing assembly creates a desired projected image on a target surface such as a wall or floor. The projected image is a representation of the image contained on the image plate.

### BACKGROUND OF THE INVENTION

1. Field of the Invention

This invention relates to the field of display technology. More specifically, the invention comprises a projection system for projecting an illuminated image on a surface such as a floor or wall.

2. Description of the Related Art

Message display devices assume a wide variety of forms. Hazard warning signs used in industrial facilities are a simple example. These use a static display of a predefined message, often including both graphical and textual elements. Many different messages are presented by such signs. Typical prior art signs include messages such as “HARD HAT AREA” and “SAFETY GLASSES MUST BE WORN.”

Some prior art displays are more sophisticated in that they are only illuminated some of the time. As an example, a display presenting the message “TEST IN PROGRESS” would only be visible when a test is in fact in progress. These more sophisticated displays are often internally illuminated by an incandescent bulb or an array of light emitting diodes. The display is simply a dark “box” on the wall when it is not illuminated. Once the internal light is switched on, however, the message becomes clear.

Prior art displays tend to be as large as the message being displayed. In other words, if the message needs to be 36 inches by 36 inches, then the display device needs to be at least that large. For an illuminated sign on a wall, the display itself often becomes bulky and heavy.

The placement of a display device on a floor surface is known in the prior art—messages painted on a road surface being one example—but for obvious reasons these tend to be static messages (“RIGHT TURN ONLY” etc.). While it is possible to place a changeable message on a floor surface, the display must be quite durable and it consequently tends to be rather expensive.

It would be advantageous to provide a display device that does not need to be as large as the message it displays. It would also be advantageous to provide a relatively inexpensive display device that can display a message on a floor surface. The present invention provides these advantages, among others.

### BRIEF SUMMARY OF THE PRESENT INVENTION

The present invention comprises a message display that produces a visible message by projecting an image on a surface such as a wall or floor. A bright light source is provided, preferably including an array of light emitting diodes (“LED's”). The light from this bright source is passed through one or more lenses in a condenser assembly to make it more uniform. The light then passes through an image plate that contains a small version of the image to be displayed. The image plate may be a static image or an active device such as an LCD.

Once the light passes through the image plate it next passes through a focusing assembly. The focusing assembly preferably includes a compensator lens, a variator lens, and a moveable objective lens. The focusing assembly preferably allows the zoom, collimation, focal length, and focus of the image to be adjusted. These features are used to create a desired projected image on a target surface such as a wall or floor. The projected image is a representation of the image contained on the image plate.

The present invention allows the creation of an image that is much larger than the device creating it. It also allows the projection of an image on a floor surface. The device may also be switched on and off or otherwise altered in order to alter the message in the display.

### BRIEF DESCRIPTION OF THE SEVERAL VIEWS OF THE DRAWINGS

FIG. 1 is a perspective view, showing an embodiment of the present invention oriented to project a message on a floor.

FIG. 2 is a perspective view, showing how the present invention may be mounted to a column.

FIG. 3 is a perspective view, showing how the present invention may be oriented to project an image on a vertical surface such as a wall.

FIG. 4 is a perspective view, showing the projection of an image on a vertical wall.

FIG. 5 is an elevation view, showing details of an exemplary condenser assembly.

FIG. 6 is a sectional elevation view, showing details of an exemplary focusing assembly.

FIG. 7 is an elevation view, showing the light source, condenser assembly, image plate, and focusing assembly.

FIG. 8 is an elevation view, showing the components of FIG. 7 enclosed within a simple depiction of the housings used to contain the components.

FIG. 9 is a sectional elevation view, showing a representative embodiment of the electronics housing, the image module housing, and the focusing module housing.

FIG. 10A is a perspective view, showing the housing embodiments of FIG. 9 attached to a mounting bracket.

FIG. 10B is a perspective view, showing the components of FIG. 10A attached to a mounting flange rather than a mounting bracket.

FIG. 11 is a perspective view, showing the use of an LCD as the image plate.

### REFERENCE NUMERALS IN THE DRAWINGS

| | | | |
|---|---|---|---|
| 10 | message projector | 12 | image footprint |
| 14 | message | 16 | column |
| 18 | mounting bracket | 20 | wall |
| 22 | door | 24 | floor |
| 26 | condenser assembly | 28 | image plate |
| 30 | projection axis | 32 | focusing assembly |
| 34 | focus lens | 36 | compensator lens |
| 38 | variator lens | 40 | rear objective lens |
| 42 | front objective lens | 44 | first condenser lens |
| 46 | second condenser lens | 48 | light source |
| 50 | mounting plate | 52 | electronics module |
| 54 | image module | 56 | focusing module |
| 58 | electronics housing | 60 | image module housing |
| 62 | focusing module housing | 64 | connection |
| 66 | connection | 68 | compensator lens carrier |
| 70 | compensator lens lock screw | 72 | variator lens carrier |
| 74 | variator lens lock screw | 76 | front objective lens carrier |
| 78 | threaded connection | 80 | vent |
| 82 | pivot | 84 | LCD display |
| 86 | electrical connector | 88 | mounting flange |
| 90 | fan | 92 | circuit board |

### DETAILED DESCRIPTION OF THE INVENTION

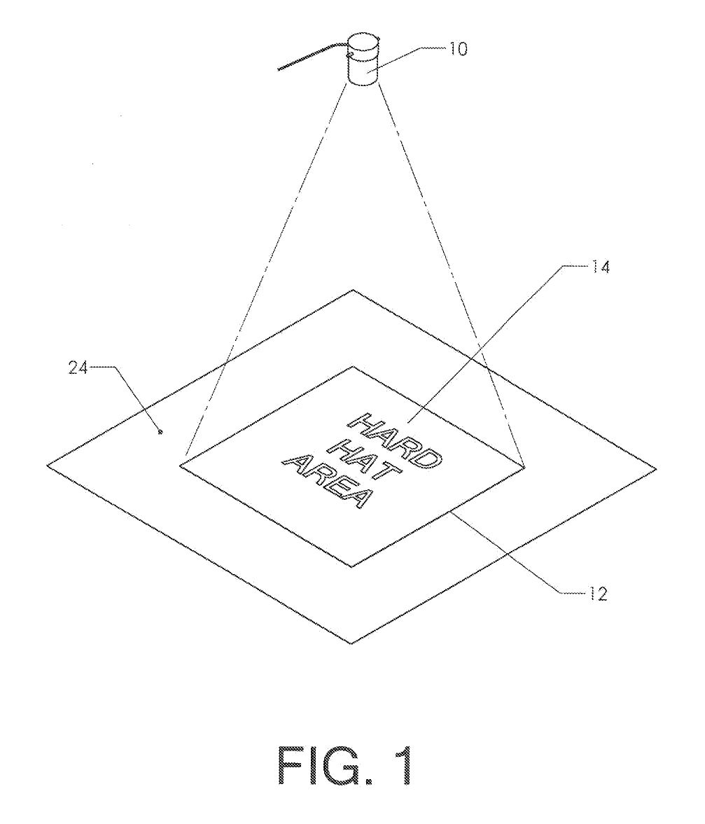

FIGS. 1-4 show typical uses for the present invention, while the subsequent drawing views show internal details for some of the representative embodiments. FIG. 1 shows an application where the desire is to project an image on a floor surface. Message projector 10 is secured in an elevated position. It is oriented to project a focused image on floor 24. The projected image lies within image footprint 12. In the particular example shown, the message “HARD HAT AREA” is projected.

The brightness of the projected image may be configured for the particular application. For example, in a factory having little external illumination, moderate brightness will allow the image to easily capture the attention of persons walking in the area. If on the other hand solar illumination is present, the brightness may need to be increased.

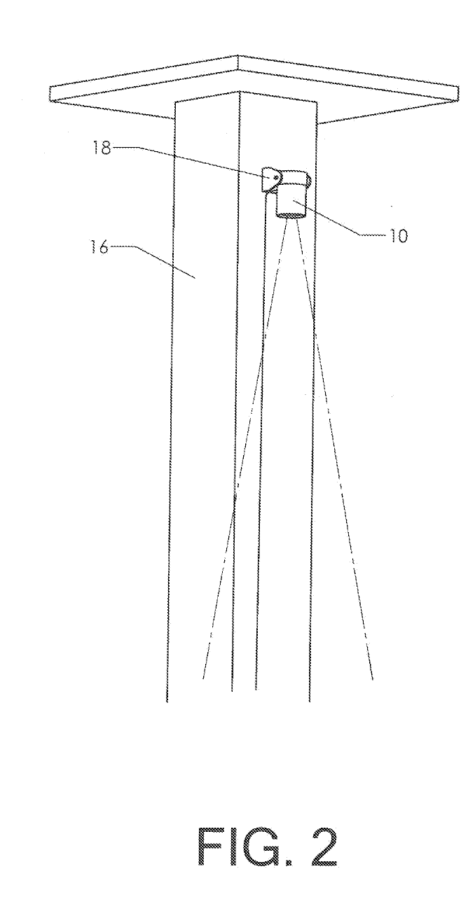

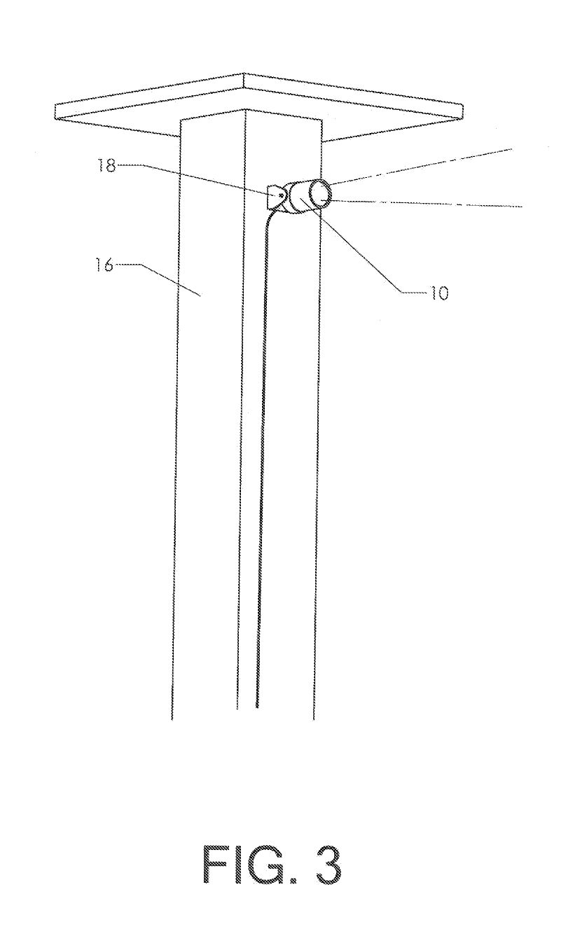

Suitable mounting hardware is preferably provided for the image projector. FIG. 2 shows an embodiment in which mounting bracket 18 is provided for message projector 10. Mounting bracket 18 is used to connect the message projector to a vertical column 16. The mounting bracket preferably allows the angle of the message projector to be adjusted. FIG. 3 shows an embodiment where message projector 10 is reoriented to project a message in a horizontal direction (in order to project the message on a vertical surface such as a wall).

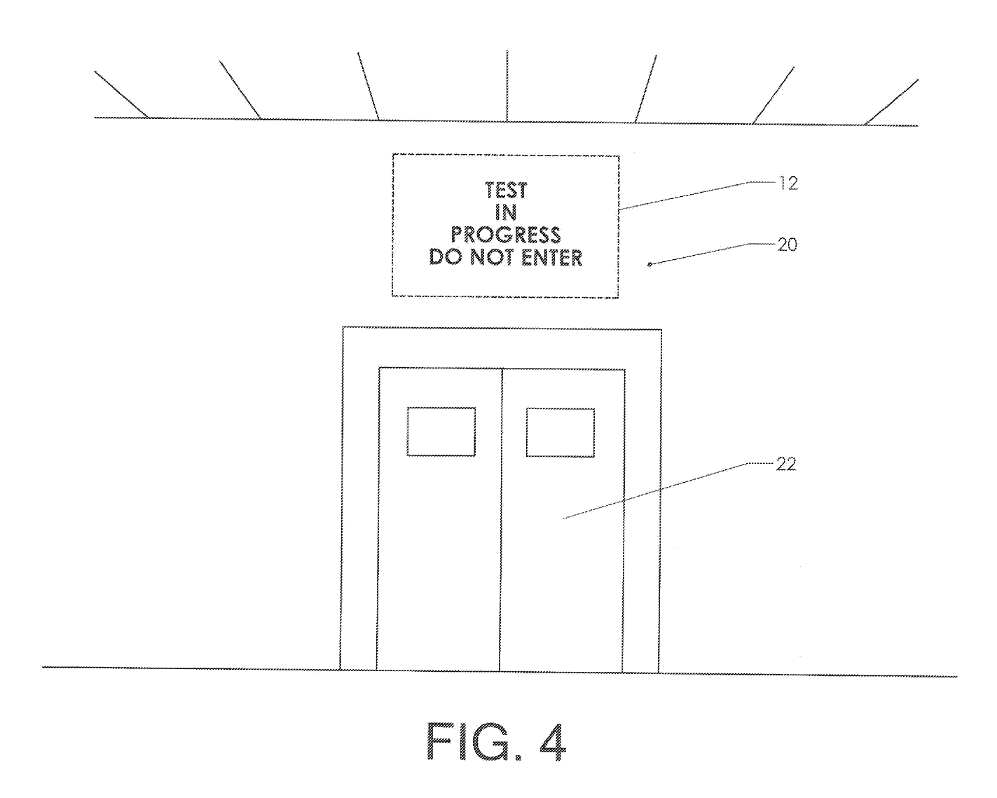

FIG. 4 shows the projection of a message on a vertical wall 20. The message “TEST IN PROGRESS DO NOT ENTER” is projected over door 22. This message alerts an approaching person of the fact that the area has been secured and should not be entered.

The message projector is able to replace conventional signage, and may provide additional features. Embodiments of the message projector may contain one or more of the following features:

(1) The ability to turn a message on and off;

(2) The ability to alter the brightness of a message in response to changing ambient conditions or other conditions;

(3) The ability to project a message in one or more colors;

(4) The ability to project a message on a surface that is not purely perpendicular to the axis of projection, including oblique and curved surfaces; and

(5) The ability to switch a message on or otherwise alter a message in response to an environmental condition—such as a proximity sensor sensing the approach of a factory worker.

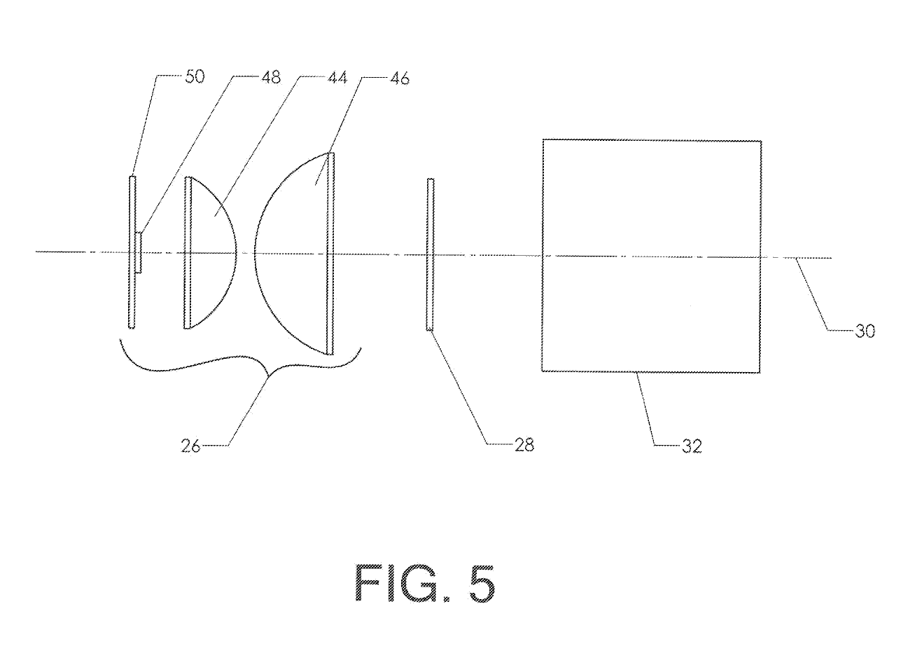

Having gained an understanding of the invention's applications, the reader may wish to know some internal details of some exemplary embodiments. FIG. 5 shows the basic components of a preferred embodiment. Light travels through the assembly from left to right in the view.

Light source 48 preferably provides illumination over a significant area. In the embodiment shown, an array of bright light emitting diodes (“LED's”) is used. A suitable array is the CSM 360 LED marketed by Luminus Devices, Inc., of Billerica, Mass., U.S.A. The CSM 360 includes an array of LED's mounted on a single chip. The array is capable of producing 6,000 lumens with a color spectrum from 3,000 K to 6,500 K. The input power is typically 40 to 80 W using a 12 V source.

Condenser assembly 26 is positioned to collect the diverging light from light source 48 and create a roughly parallel light source. First condenser lens 44 and second condenser lens 46 focus parallel light rays through image plate 28. Image plate 28 contains the image of the message that is to be projected. It may be relatively small—such as 8 mm by 8 mm. Once the light rays pass through image plate 28 they enter focusing assembly 32. The focusing assembly adjusts the optical path in order to project an image along projection axis 30 and focus that image on a target surface.

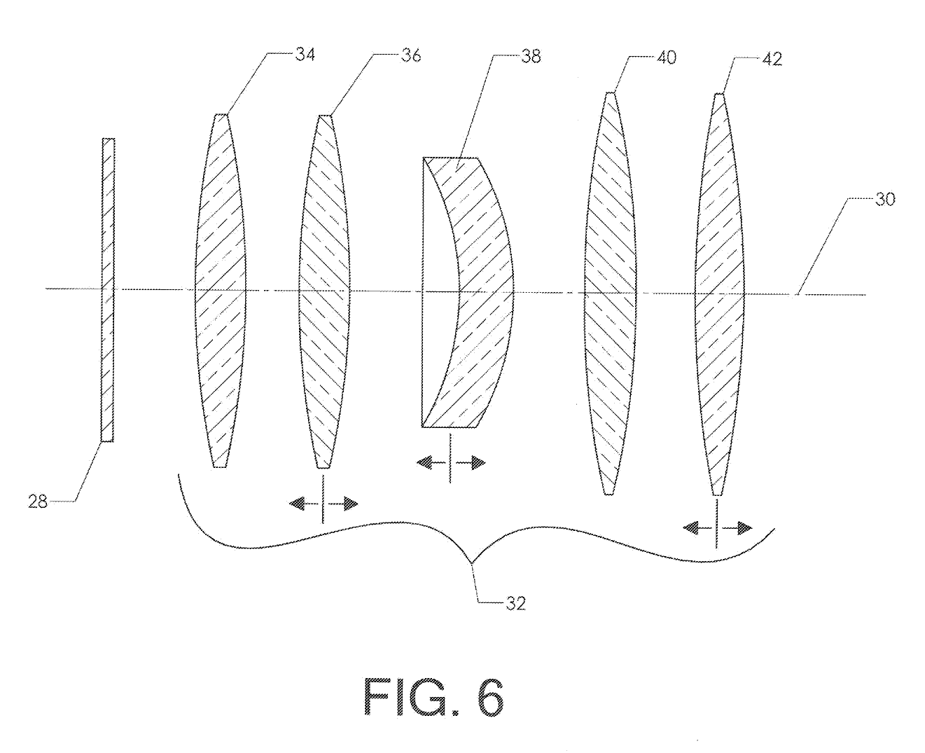

FIG. 6 shows a representative embodiment of focusing assembly 32 (in a sectioned view). From left to right, the assembly includes: focus lens 34, compensator lens 36, variator lens 38, rear objective lens 40, and front objective lens 42. All the lenses are centered on projection axis 30. Light passing through image plate 28 travels through the focusing assembly and out along projection axis 30.

While a discussion of optical design is beyond the scope of this disclosure, the reader may wish to understand the general function of the lenses in the embodiment presented. The light rays converge as they pass into image plate 28 from the left and diverge as they pass out to the right. Focus lens 34 reduces the angle of divergence. Compensator lens 36 further reduces the angle of divergence. The double-headed arrow shown in conjunction with compensator lens 36 is intended to indicate that its position along projection axis 30 is preferably adjustable. This allows for collimation adjustment.

The position of variator lens 38 is preferably also made adjustable. As will be understood by those knowledgeable in the field, the motion of a variator lens alters the focal length of the lens assembly (and therefore the “zoom”). In the embodiment shown, the variator lens provides a “zoom” adjustment between 1:1 and 2.7:1.

Rear objective lens 40 is fixed in position for the embodiment shown. Front objective lens 42, however, is preferably made adjustable. Adjusting the separation between the two objective lenses varies the projection distance for the assembly (the distance between the front objective lens and a focused image projected on a surface). In the embodiment shown, the projection distance may be varied between 15 feet and 40 feet (4.6 m and 12.3 m). A simpler lens assembly can certainly be used. A more complex one could be used as well. However, the embodiment shown provides good flexibility in terms of the projection distance and the projected image size.

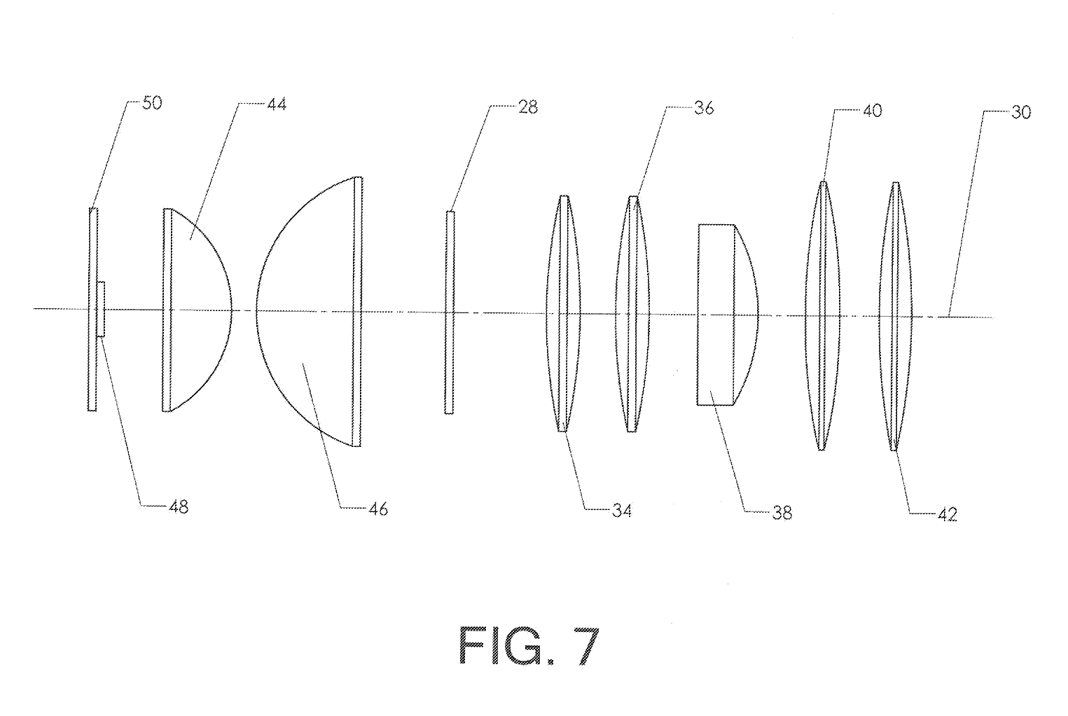

FIG. 7 shows the entire optical path from light source 48 to front objective lens 42. In sequence, the components are as follows: light source 48, first condenser lens 44, second condenser lens 46, image plate 28, focus lens 34, compensator lens 36, variator lens 38, rear objective lens 40, and front objective lens 42.

The reader may wish to know some specific examples for the lenses used in the assembly. All the lenses in the exemplary embodiment are marketed by Thorlabs, Inc., of Newton, N.J., U.S.A. First condenser lens 44 is an aspheric condenser lens having model number ACL 4532. It has an overall diameter of 45 mm and a focal length of 32 mm. Second condenser lens 46 is a Thorlabs model number ACL 7560. It has an overall diameter of 75 mm and a focal length of 60 mm.

The components within the zoom lens assembly may be any suitable combination of convex and variator lenses. In the preferred embodiments, these lenses will be made of glass. However, for less expensive embodiments, the lenses may be made of plastic.

The image plate may assume a wide variety of forms. In its simplest form it may be a “Gobo” mask. Such masks are used in theatrical lighting and may assume many forms. A simple one-color Gobo may be an image cut into a thin steel plate. A more complex Gobo may include multiple layers of glass plates. A multi-layer Gobo is often used to produce a full-color image. A Gobo mask creates a projected image by passing light through a pattern lying in the focal plane. More complex embodiments are possible, including the use of a computer-controlled LCD panel to create a changeable mask. The image plate includes a clear area corresponding to the message, with the balance of the area being opaque. The term “clear area” is not limited to a 100% transmission of light. In an LCD display—for example—the “clear area” may only correspond to a transmissibility of about 60%. As long as there is a significant difference in transmissibility between the clear and non-clear areas the functional purpose of the image plate will be met.

The description of the “clear area” corresponding to the message means that the clear area will define a small version of the message that is to be projected on the target surface. The clear area may assume a complex form such as text (“HARD HAT AREA”) or a simple form such as a graphical arrow.

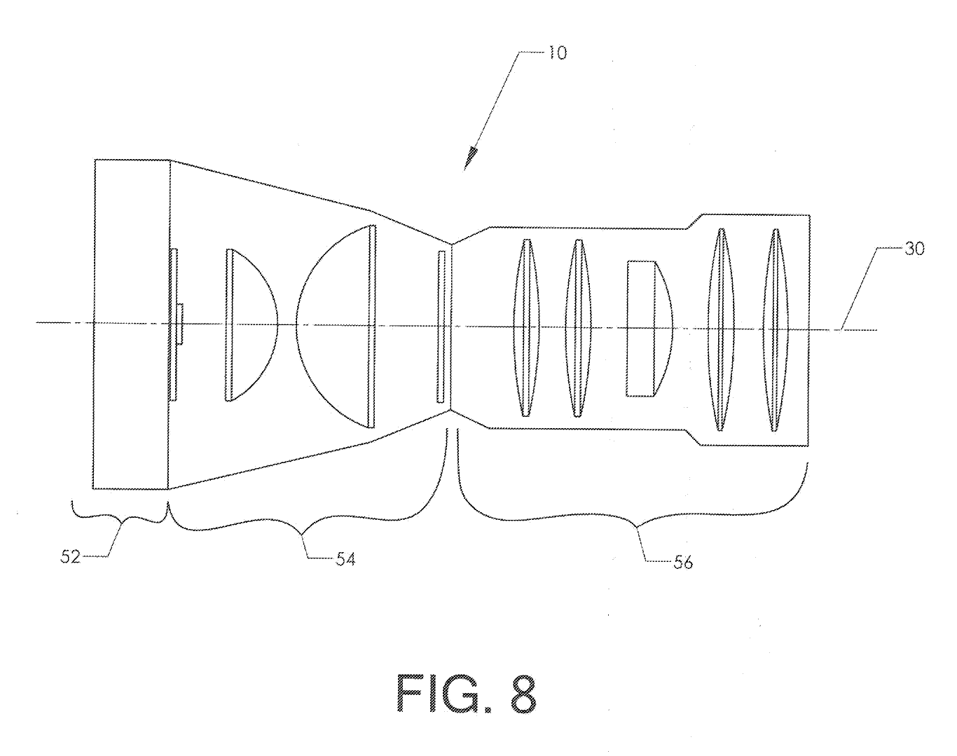

FIG. 8 shows a simplified view of a combined housing that may be used to contain the light source, the condensing lenses, and the focusing lenses. Electronics module 52 contains the circuitry providing power to the light source and mounts the light source itself. Image module 54 contains the condensing lenses and the image plate. Focusing module 56 contains the lenses used to project and focus the desired image.

The assembly shown includes three separate modules that are linked together. Other embodiments may include only two separate modules, while still other embodiments may use a single module to contain all the components.

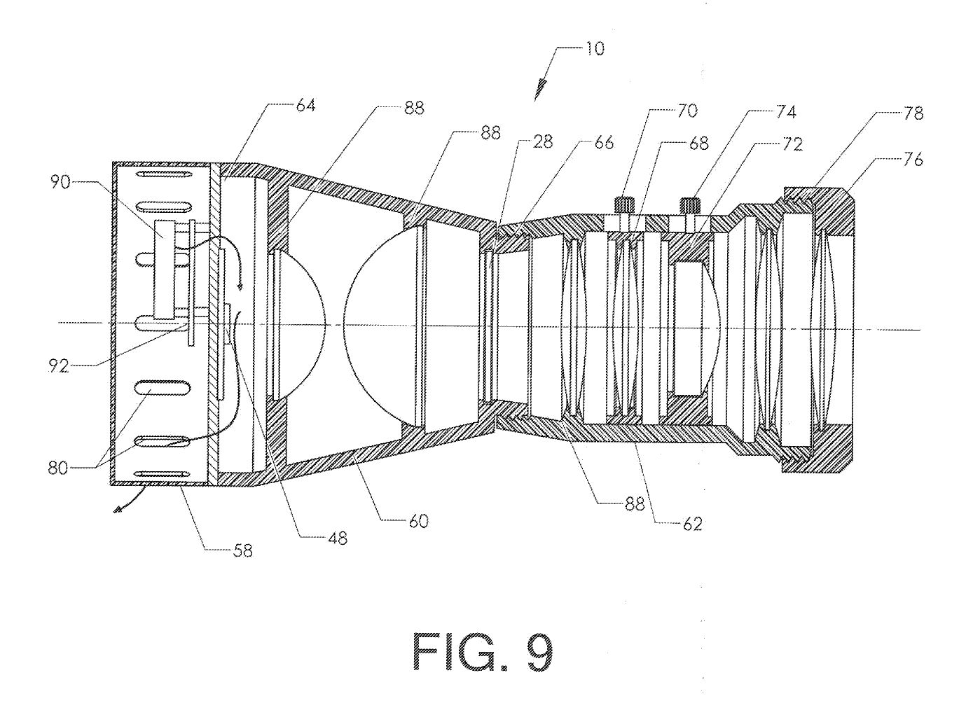

FIG. 9 shows a sectioned elevation view taken through a completed assembly in which representative housings for each of the modules are depicted in a simplified fashion. In the embodiment shown, most of the housing components are made of molded plastic. Electronics housing 58 is joined to image module housing 60. Image model housing 60, in turn, is joined to focusing module hosing 62.

In the embodiment shown, electronics housing 58 is made of molded plastic but includes an integral metal plate. Light source 48 is attached to the metal plate. Circuit board 92 is also attached to the metal plate, using conventional standoffs to provide a separation for cooling. Fan 90 may be attached to the housing, to the circuit board, or to the metal plate.

Circuit board 92 includes the electronics necessary to drive light source 48 and fan 90. For embodiments using an active image plate, it may also include the circuitry to control the image. Fan 90 draws air into the housing through one or more vents 80. The air is preferably circulated around the circuit board and around light source 48. A suitable gap is preferably provided between light source 48 and the first of the condenser lenses so that air can circulate around the light source. The heated air is exhausted from the housing as shown.

In the version of FIG. 9, image module housing 60 is attached to electronics housing 58 via connection 64, which may assume any suitable form. The image module housing contains the two condenser lenses and image plate 28. The housing is preferably made from molded plastic. It preferably includes internal fixtures for receiving and holding the lenses in the desired position. The housing depicted may be molded in two halves. If this approach is used, the lenses are then placed in one of the two halves and the other half is secured in place to complete the assembly.

Another alternative is to use a one-piece housing that includes flexible features to hold the optical components. As an example, thin and flexible annular ribs can be positioned to snap over the perimeter of each lens. Each lens in pushed into place and a flexible rib snaps over the lens' perimeter to secure it in position.

In the embodiment of FIG. 9, the housing is molded in two halves. A series of retention ribs 88 are provided. These include annular recesses designed to receive the outer perimeter of each lens. The lenses are placed in one of the two halves. The other half is then mated in position, at which point the annular recesses completely encircle and capture the lenses. Of course, one could also use a series of posts and snaps that grip only a portion of each lens. However the attachment is made between the lenses and the image module housing, the lenses should be held securely in place.

Focusing module housing 62 is connected to image module housing 60 by threaded connection 66 in the particular version shown. The image module housing may also be made as one or more injection molded parts. Retention features are provided for holding focus lens 34 and rear objective lens 40 in fixed positions. However, if an embodiment having movable lenses is desired, features for facilitating the movement of the movable lenses must be incorporated. In the version shown, compensator lens 36, variator lens 38, and front objective lens 42 are all movable.

Compensator lens carrier 68 holds the compensator lens. It slides along the projection axis. Compensator lens lock screw 70 is tightened in order to lock the compensator lens in a desired position. Likewise, the variator lens is carried in variator lens carrier 72. Variator lens lock screw 74 it tightened to lock the variator lens in position. The two lock screws pass through slots in the exterior of the focusing module housing so that they are externally accessible.

The front objective lens is connected to front objective lens carrier 76. The front objective lens carrier is connected to the focusing module housing via threaded connection 78. The distance between the two objective lenses is therefore adjusted by rotating front objective lens carrier 76.

The housing embodiments are depicted in a simplified fashion and the invention is by no means limited to the embodiments shown. Those skilled in the art will know that many different types of housing could be used. Suitable housings can be constructed to provide the following features, among others:

(1) weather resistance for outdoor applications using cast zinc or other materials;

(2) a hermetically-sealed enclosure in order to minimize condensation and fogging;

(3) an electrically-insulated enclosure;

(4) a one-piece construction that resists tampering and disassembly; and

(5) a modular construction that allows the substitution of different image and focusing modules.

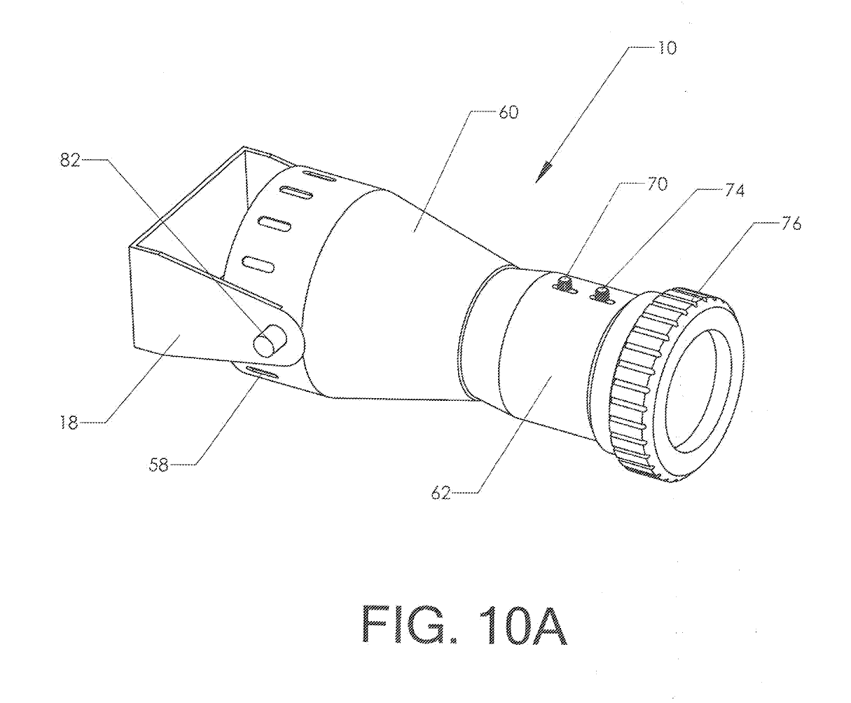

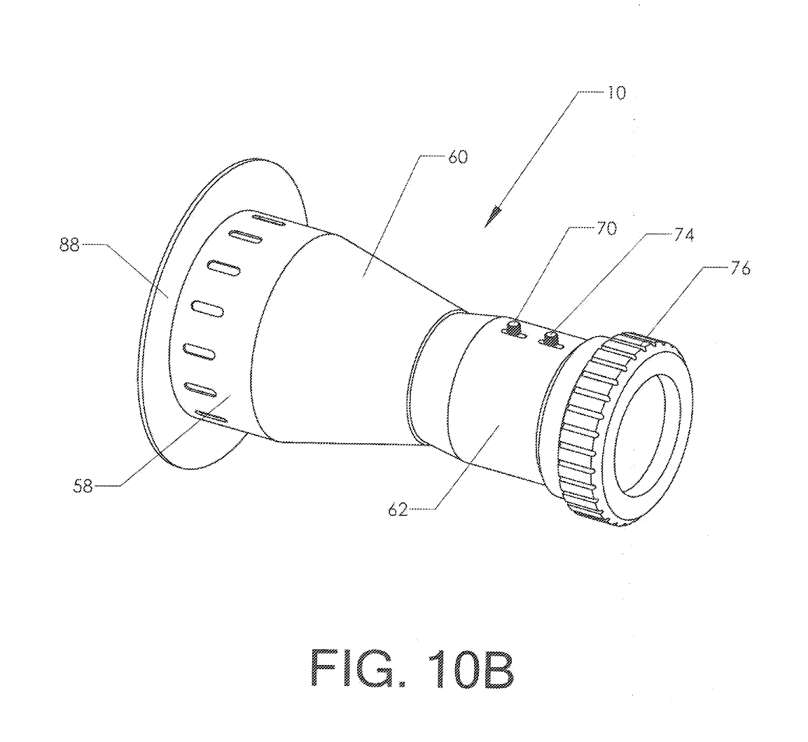

The assembly of FIG. 9 must be mounted to a wall, ceiling, or other support to operate. Electronics housing 58 itself may serve as a mounting bracket. Alternatively, external mounting features may be added. FIGS. 10A and 10B show embodiments in which additional mounting features have been added. In FIG. 10A, mounting bracket 18 is connected to electronics housing 58. A locking pivot 82 is preferably provided so that the angle between the mounting bracket and the rest of the assembly may be adjusted. In use, mounting bracket 18 may be attached to a ceiling, a wall, or some other structure. Message projector 10 is then attached to the mounting bracket.

Several other significant features are seen in FIG. 10A. The reader will observe how compensator lens lock screw 70 and variator lens lock screw 74 protrude out of the slots in the focusing module housing. To adjust the position of one of these lenses, the user loosens the lock screw, slides the lens to a new location, and tightens the lock screw again. The reader will also observe that front objective lens carrier 76 includes gripping features around its perimeter. These allow a user to easily grasp and rotate the front objective lens carrier in order to change the separation distance between the two objective lenses.

The adjustments to the lens locations will ordinarily be made with the light source switched on (and in the case of an active image plate the image may be active or a test pattern may be active). The user will ordinarily make the adjustments by observing the projected image itself.

FIG. 10B shows an alternate mounting bracket. In this embodiment, mounting flange 88 has been added to the base of electronics housing 58. The mounting flange may incorporate holes or other features that facilitate its attachment to an external object. For example, if message projector 10 is to be placed on a ceiling, mounting flange 88 may include openings arranged to facilitate attachment of the flange to an electrical junction box. Many types of mounting features could be added and the invention is in no way limited to any particular feature or features.

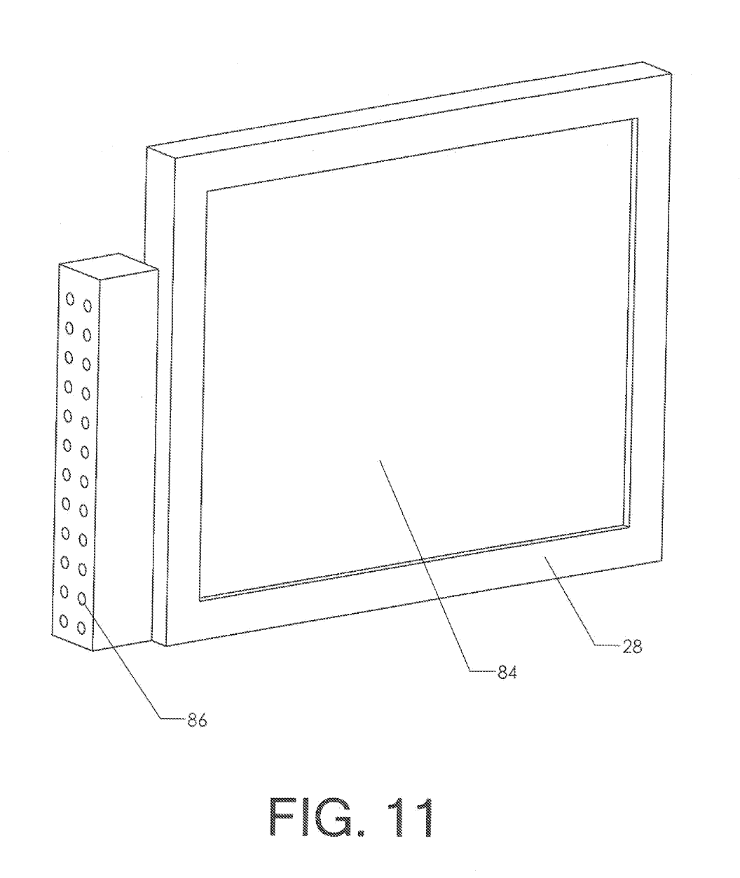

FIG. 11 shows one embodiment of an “active” image plate 28. The term “active” is used to indicate that the image plate is not limited to a static image (such as a metal “Gobo” plate). In the embodiment shown, the light path is directed through LCD display 84. Electrical connector 86 connects the LCD display to suitable electronics located in the electronics housing. In other embodiments, the electronics may be located with the LCD display.

The LCD display will typically create a “negative” image, meaning that the desired message will be presented as a clear area and the rest of the display will be dark. Light will be transmitted through the clear area in order to form the projected image.

Those skilled in the art will realize that many other display technologies could be substituted for the LCD display shown. Any existing or future technology used in flat-screen displays could likely be applied, and the invention is by no means limited to any particular technology.

The use of an “active” display allows additional possibilities for the projected message, including:

(1) the use of a variety of colors;

(2) the use of animation;

(3) the use of different messages, possibly in response to different conditions; and

(4) the use of time-driven messages (such as “45 DAYS WITHOUT A LOST-TIME ACCIDENT”).

The lens adjustment embodiments shown in FIGS. 6 and 9 should properly be viewed as simplistic embodiments. In particular, the sliding carriages shown in FIG. 9 would likely be replaced by more sophisticated in some embodiments. Mechanisms similar to those used in camera lenses may be employed. For instance, the variator and objective lens adjustment features can be combined in one external grip that can be moved along the projection axis and also turned (in the manner of a camera zoom lens where a single device controls focus and zoom).

Focusing features may be automated using the focusing technology found in present day cameras. Zoom may be controlled remotely if a drive system is installed in the focusing module. Remote control of the zoom feature allows the projected image to shrink and grow on command. This could be useful. Assume, for example, the presence of a “TEST IN PROGRESS—DO NOT ENTER MESSAGE.” This could be presented in a modest size. If a control system detects a person continuing to walk toward the secured area, the controller could command the message projector to simultaneously enlarge and flash the projected image. All these possibilities will be understood by those knowledgeable in the field.

In a typical installation, the installer will mount the image projector and then switch the light source on in order to adjust the projected image. One of the objectives may be to correctly adjust the “depth of field.” This is significant factor when the image is projected on a surface that is not wholly perpendicular to the projection axis (such as a curved or oblique surface). A greater depth of field allows more of an image to be in focus when it is projected on a non-perpendicular surface.

Adjusting the lenses themselves can increase the depth of field. Other features may be added if needed. For example, an adjustable iris can be provided to increase the depth of field, albeit at the expense of overall brightness.

Although the preceding description contains significant detail, it should not be construed as limiting the scope of the invention but rather as providing illustrations of the preferred embodiments of the invention. Those skilled in the art will know that many other variations are possible without departing from the scope of the invention. Accordingly, the scope of the invention should properly be determined with respect to the following claims rather than the examples given.

Having described our invention, we claim:

1. A method for displaying a message on a target surface, comprising:
a. providing a message projector, including,
i. a light source,
ii. a projection axis,
iii. an image plate lying on said projection axis, said image plate having a first side and a second side, wherein said image plate includes a clear portion corresponding to said message,
iv. a condenser assembly lying on said first side of said image plate between said light source and said image plate, said condenser assembly directing light emitted by said light source through said image plate,
v. a focusing assembly lying on said second side of said image plate, said focusing assembly configured to focus said light passing through said image plate on said target surface;
b. attaching said message projector to a fixed external object, with said projection axis being directed toward said target surface; and
c. activating said light source so that said light from said light source passes through said image plate, through said condenser assembly, through said focusing assembly, and out along said projection axis, said light forming said message on said target surface.

2. A method for displaying a message on a target surface as recited in claim 1 wherein said light source is an array of light emitting diodes.

3. A method for displaying a message on a target surface as recited in claim 2, further comprising providing an electronics housing, wherein said electronics housing includes:
a. a plate for mounting said array of light emitting diodes;
b. a circuit board; and
c. a cooling fan.

4. A method for displaying a message on a target surface as recited in claim 3, further comprising:
a. providing an image module housing attached to said electronics housing; and
b. wherein said image module housing contains said condenser assembly and said image plate.

5. A method for displaying a message on a target surface as recited in claim 4, wherein said condenser assembly contains a first condenser lens and a second condenser lens lying between said first condenser lens and said image plate.

6. A method for displaying a message on a target surface as recited in claim 4, further comprising:
a. providing a focusing module housing attached to said image module housing; and
b. wherein said focusing module housing contains said focusing assembly.

7. A method for displaying a message as recited in claim 6, wherein said focusing module includes a movable variator lend for adjusting zoom.

8. A method for displaying a message as recited in claim 7, wherein said focusing module further comprises:
a. a rear objective lens;
b. a front objective lens separated from said rear objective lens by a distance; and
c. wherein said distance between said front and rear objective lenses is adjustable.

9. A method for displaying a message as recited in claim 1, wherein said image plate is an active image plate capable of changing the shape of said clear portion in order to change said message.

10. A method for displaying a message as recited in claim 9, wherein said active image plate is under the control of a computing device.

11. A method for displaying a message on a target surface, comprising:
a. providing a message projector, including,
i. a light source,
ii. a projection axis,
iii. an image plate lying on said projection axis, said image plate having a first side and a second side, wherein said image plate includes a clear portion corresponding to said message,
iv. a condenser assembly lying on said first side of said image plate between said light source and said image plate, said condenser assembly directing light emitted by said light source through said image plate,
v. a focusing assembly lying on said second side of said image plate, said focusing assembly configured to focus said light passing through said image plate on said target surface;
b. permanently mounting said message projector to a fixed external object, with said projection axis being directed toward said target surface; and
c. activating said light source so that said light from said light source passes through said image plate, through said condenser assembly, through said focusing assembly, and out along said projection axis, said light forming said message on said target surface, wherein said message includes an illuminated graphic within a non-illuminated image footprint.

12. A method for displaying a message on a target surface as recited in claim 11 wherein said light source is an array of light emitting diodes.

13. A method for displaying a message on a target surface as recited in claim 12, further comprising providing an electronics housing, wherein said electronics housing includes:
a. a plate for mounting said array of light emitting diodes;
b. a circuit board; and
c. a cooling fan.

14. A method for displaying a message on a target surface as recited in claim 13, further comprising:
a. providing an image module housing attached to said electronics housing; and
b. wherein said image module housing contains said condenser assembly and said image plate.

15. A method for displaying a message on a target surface as recited in claim 14, wherein said condenser assembly contains a first condenser lens and a second condenser lens lying between said first condenser lens and said image plate.

16. A method for displaying a message on a target surface as recited in claim 14, further comprising:
a. providing a focusing module housing attached to said image module housing; and
b. wherein said focusing module housing contains said focusing assembly.

17. A method for displaying a message as recited in claim 16, wherein said focusing module includes a movable variator lend for adjusting zoom.

18. A method for displaying a message as recited in claim 17, wherein said focusing module further comprises:
a. a rear objective lens;
b. a front objective lens separated from said rear objective lens by a distance; and
c. wherein said distance between said front and rear objective lenses is adjustable.

19. A method for displaying a message as recited in claim 11, wherein said image plate is an active image plate capable of changing the shape of said clear portion in order to change said message.

20. A method for displaying a message as recited in claim 19, wherein said active image plate is under the control of a computing device.
